(19) United States
(12) Patent Application Publication
(10) Pub. No.: US 2023/0356965 A1
(43) Pub. Date: Nov. 9, 2023

(54) METHOD FOR TRANSPORTING GOODS IN CONTAINERS IN TWO LAYERS AND A WAGON FOR TRANSPORTING THE CONTAINERS

(71) Applicant: LAUDE SMART INTERMODAL SPOLKA AKCYJNA, Torun (PL)

(72) Inventor: Marcin WITCZAK, Torun (PL)

(21) Appl. No.: 18/224,457

(22) Filed: Jul. 20, 2023

Related U.S. Application Data
(63) Continuation-in-part of application No. 16/860,812, filed on Apr. 28, 2020.

(30) Foreign Application Priority Data
Jul. 12, 2019 (PL) P.430571

(51) Int. Cl. B65G 63/02; B61D 45/00; B61D 3/02

(52) U.S. Cl. CPC B65G 63/025; B61D 45/007; B61D 45/003; B61D 3/02

(57) ABSTRACT

A method for transporting goods consisting of carrying two layers of containers on a wagon, characterized in that the bottom layer comprises containers without side walls, loading and unloading the goods carried on the bottom layer independently from the goods carried on the top layer, transporting coils in the bottom containers, loading and unloading coils by inserting a coil lifter arm through inner diameter of the coil, wherein the wagon for transporting containers contains bogies and a platform with side walls arranged between said bogies, wherein the height of the side wall extending over the platform in its lowest point does not exceed 60 cm, wherein the wagon has a side wall extending 55-60 cm above the platform containing trapezoid reduced-height sections, wherein the side wall has the height of 20-40 cm and extends 40-45 cm above the platform in said reduced-height sections and contain a top reinforcing member, characterized in that the side wall and the top reinforcing member are linked with connecting members.

### CROSS REFERENCE TO RELATED APPLICATIONS

The present application is a continuation-in-part of the U.S. patent application Ser. No. 16/860,812, filed on Apr. 28, 2020, which claims priority to Polish Application P.430571, filed on Jul. 12, 2019, the contents of each of which are incorporated by reference in their entirety for all purposes.

### FIELD OF THE INVENTION

The present invention relates to a method for transporting goods in containers and the wagon for transporting containers. The method relates to a double-stack transport of goods on wagons that carry two layers of containers. The wagon is intended for use in double-stack rail transport. The top containers are secured to the bottom containers.

### BACKGROUND

A method for transporting goods in containers where the wagon platform carries two layers of containers is known from the art. Each layer comprises of one or two containers. The double-stacking pattern is usually a single 40-feet container or two 20-feet containers. The top container(s) are secured to the bottom container(s). The goods from the bottom container can be unloaded by removing the top container(s), and removing the bottom container. With the ‘open top’ containers, the goods can be unloaded from the top by removing the top container(s) and opening the bottom container.

US2018001911 discloses a wagon with bogies and a platform with side walls arranged between said bogies. The platform is positioned below the upper edge of the bogie. The side walls provide structural rigidity and are half the height of the container.

In order to transport containers in two layers, wagons are generally used that have a platform for transporting containers placed between two bogies. This allows the containers to be placed lower. This solution is similar to low-floor passenger cars used in trains and trams. Stability of such arrangement requires that the heavier container be placed in the lower layer as raising the center of gravity may lead to train overturning at the turn of the rails. An example of such transportation can be loading a container with steel coils and a container with light goods. In such case, the container with the steel coils has to be placed at the bottom and the container with the light goods at the top. The known wagons of this type have high side walls. They provide structural rigidity but prevent side access to the lower container. For example, it is not possible to insert the appropriate tool inside the coils to remove them from the container.

Generally, loading and unloading goods between various stations, using containers with the high side walls, may have the following order: A train has to stop at stations A, B, C, D. At station A a manufacturer of fabrics is located. At station B an ironworks is located. At station C a car factory is situated, and a sewing factory is located at station D. Using the existing wagons and methods, a process of transportation, loading and unloading is generally as follows: At station A, a container with fabrics is loaded. At station B, the container with the fabric is removed, the container with the steel is placed on the bottom layer, and the container with the fabrics is placed on top of the bottom container containing the steel. At station C, the top container with the fabrics is removed, then the bottom container with the steel is removed, and the top container with is loaded with fabrics. At station D, the container with the fabrics is unloaded. In total, there are 8 loading and unloading operations and there is space needed to put down the container from the top layer.

### SUMMARY

The object of the invention is to provide a method of transporting goods in which there will be fewer operations and no space is required to put down a light container.

The aim is also to construct a wagon enabling the use of the new method.

The present invention relates to a method for transporting goods in containers, wherein the wagons carry two layers of containers, characterized in that the bottom containers are the containers without side walls what allows an access to content of the bottom container without removal of the top container. The goods in the bottom containers are loaded and unloaded independently from the goods in the top containers. The top containers are standard containers or containers without side walls. Preferably, the bottom containers are used for transporting coils. Preferably, the coils are loaded and unloaded by inserting a coil lifter arm through inner diameter of the coil.

The present invention relates to a wagon for transporting containers comprising bogies and a platform with side walls arranged between said bogies, characterized in that the height of the side wall extending above the platform in its lowest point does not exceed 60 cm what facilitates insertion of the coil lifter arm through inner diameter of the coil and its removal from the bottom container. It also facilitates unloading other goods from the bottom container. Preferably, the side wall of the wagon extends 55-60 cm above the platform. Preferably, the side wall comprises trapezoid reduced-height sections, wherein the side wall extends 40-45 cm above the platform in said reduced-height sections. Preferably, the side wall comprises a top reinforcing member. Preferably, the side wall and the top reinforcing member are linked with connecting members. The height of the side wall is 20-40 cm.

The method for transporting goods in containers allows to optimize transport in locations where double-stack rail transport is allowed. The capability to load and unload the bottom container without removing the top container significantly facilitates transport planning processes. Using the bottom container for transporting coils will significantly improve transport. A container with coils, e.g. steel sheets is a heavy load compared to containers with other goods and is transported as a bottom container for stability. A container for the other, lighter goods is transported as a top container. The top containers are secured to the bottom containers by twist locks.

The solution according to the invention will further increase the transport capabilities. A wagon for transporting containers according to the invention has reduced-height side wall which allows access to the goods in the bottom container. In particular, the invention allows to access the inner diameter of the coil and unload the coil from the container.

Further, according to the Applicant's solution, on station A an empty container for the coils without a side wall is loaded on the bottom. On the top of the empty container is loaded another container containing lighter goods e.g. fabrics. On station B the coils are loaded into the bottom container. On station C the coils are unloaded from the bottom container without the side wall. On station D, the top container with fabrics and the button container for the coils are unloaded. In result, time of unloading the coils and fabrics is shortened as there are only 6 loading and unloading operations in total. In addition, no additional space is required on stations B and C for the top container to be unloaded to allow loading and unloading the coils from the bottom container.

### BRIEF DESCRIPTION OF THE DRAWINGS

The embodiments of the invention are presented herein with reference to the following drawings:

FIG. 1 shows the wagon with a uniform height wall carrying a bottom container for transporting coils and any other container;

FIG. 2 shows the cross-section of the wagon;

FIG. 3 shows the wagon with reduced-height sections of the side wall;

FIG. 4 shows the wagon with top reinforcing members; and

FIG. 5 shows the wagon with the top reinforcing members and connecting members.

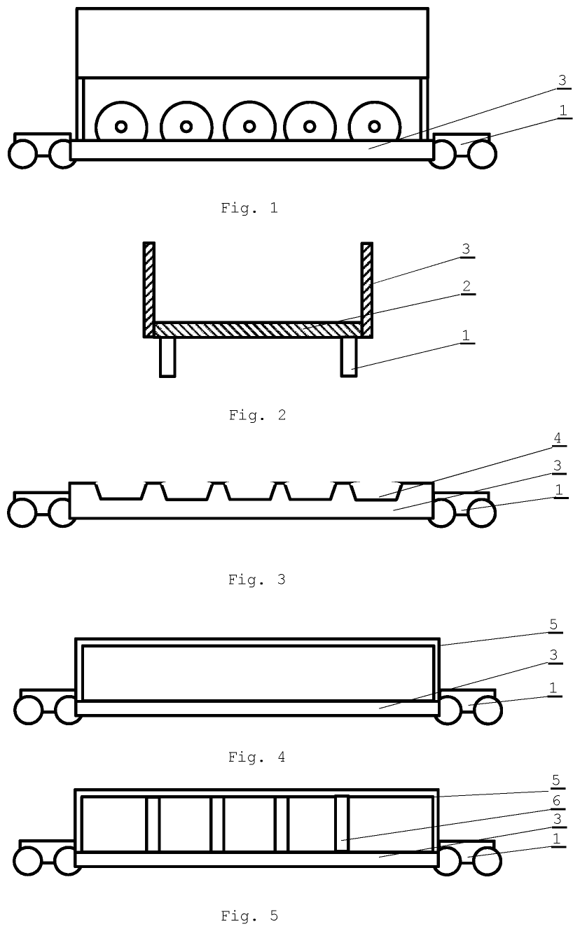

### DETAILED DESCRIPTION

Embodiment 1. A container without a side wall is positioned on the bottom layer and a standard container is positioned on the top layer of the wagon. At any stop along the route, all or part of the goods on the bottom container can be unloaded. The bottom container comprises cradles for transporting sheet metal coils. The sheet metal coils are loaded by inserting a coil lifter arm through inner diameter of the coil. A wagon for transporting containers comprises bogies 1 and a platform 2 with side walls 3 arranged between said bogies. The side wall 3 extends 58 cm above the platform 2.

Embodiment 2. A container without a side wall is positioned on the bottom layer and a standard container is positioned on the top layer of the wagon. At any stop along the route, all or part of the goods on the bottom container can be unloaded. The bottom container comprises cradles for transporting sheet metal coils. The sheet metal coils are loaded by inserting a coil lifter arm through inner diameter of the coil. A wagon for transporting containers comprises bogies 1 and a platform 2 with side walls 3 arranged between said bogies. A side wall 3 with trapezoid reduced-height sections 4. In the reduced-height sections, the side wall 3 extends 42 cm above the platform 2.

Embodiment 3. A container without a side wall is positioned on the bottom layer and a standard container is positioned on the top layer of the wagon. At any stop along the route, all or part of the goods on the bottom container can be unloaded. The bottom container comprises cradles for transporting sheet metal coils. The sheet metal coils are loaded by inserting a coil lifter arm through inner diameter of the coil. The side wall 3 comprises a top reinforcing member 5. The height of the side wall 3 is 35 cm.

Embodiment 4. A container without a side wall is positioned on the bottom layer and a standard container is positioned on the top layer of the wagon. At any stop along the route, all or part of the goods on the bottom container can be unloaded. The bottom container comprises cradles for transporting sheet metal coils. The sheet metal coils are loaded by inserting a coil lifter arm through inner diameter of the coil. The side wall 3 comprises a top reinforcing member 5. Preferably, the side wall 3 and the top reinforcing member 5 are linked with connecting members 6. The height of the side wall 3 is 20 cm.

1. A method for transporting goods in two layers of containers characterized in that
in a bottom layer the containers without side walls are placed, and next the containers in a top layer are placed, wherein loading and unloading of the goods is conducted from the containers located in the bottom layer, wherein unloading takes place from the top layer and next from the bottom layer.

2. The method according to claim 1, characterized in that the goods carried on the bottom layer are loaded and unloaded independently from the goods carried on the top layer.

3. The method according to claim 1, characterized in that the bottom containers are used for transporting coils.

4. The method according to claim 3, characterized in that the coils are loaded and unloaded by inserting a coil lifter arm through inner diameter of the coil.

5. A wagon for transporting containers for use in double-stack rail transport comprising
bogies, and
a platform with
side walls arranged between said bogies, characterized in that the height of a side wall extending over the platform in its lowest point does not exceed 60 cm, wherein bottom container comprises cradles for transporting sheet metal coils, and wherein and the top containers are secured to the bottom containers by twist locks.

6. The wagon according to claim 5, characterized in that the wagon has a side wall extending 55-60 cm above the platform.

7. The wagon according to claim 5, characterized in that the side wall comprises trapezoid reduced-height sections, wherein the side wall extends 40-45 cm above the platform in said reduced-height sections.

8. The wagon according to claim 5, characterized in that the side wall comprises a top support.

9. The wagon according to claim 8, characterized in that the side wall and the top support are linked with connectors.

10. The wagon according to claim 8, characterized in that the height of the side wall is 20-40 cm.

11. The method according to claim 1, characterized in that the goods are in the form of sheet metal coils and that the method comprises an additional step of:
loading and unloading the sheet metal coils carried on a bottom layer of the containers by inserting a coil lifter arm through inner diameter of the coil, without removing the containers from the top layer, wherein the bottom containers comprise cradles for transporting the sheet metal coils.
